(19) United States
(12) Patent Application Publication
(10) Pub. No.: US 2020/0401934 A1
(43) Pub. Date: Dec. 24, 2020

(54) GENERATED RESPONSE USING ARTIFICIAL INTELLIGENCE (AI) BASED ON BIOMETRIC DATA

(71) Applicant: International Business Machines Corporation, Armonk, NY (US)

(72) Inventors: Craig M. Trim, Ventura, CA (US); Jeremy R. Fox, Georgetown, TX (US); Zachary A. Silverstein, Austin, TX (US); Sarbajit K. Rakshit, Kolkata (IN)

(21) Appl. No.: 16/448,803

(22) Filed: Jun. 21, 2019

(51) Int. Cl. G06N 20/00; G06N 5/02

(52) U.S. Cl. CPC G06N 20/00; G06N 5/02

(57) ABSTRACT

An artificial intelligence-based method includes calculating, by a wearable device, a biometric index based on a plurality of biometric indicators associated with a user of the wearable device, based on the biometric index exceeding a threshold, identifying a change in a context of the user, determining whether the calculated biometric index is associated with the change in the context, based on the calculated biometric index being associated with the change, searching for an Internet of Things device available within the context, transmitting a notification to the Internet of Things device requesting assistance to the user, and in response to transmitting the notification, measuring a change in the biometric index.

### BACKGROUND

The present invention generally relates to the field of artificial intelligence (AI), and more particularly to an Internet of Things (IoT) based cognitive system, method and computer program product for generating a response based on biometric data.

The Internet has adopted many new technologies as it has evolved to meet the changing needs of industry and society. This flexibility has been a factor in its growth, and today's Internet spans the globe and brings voice, video, data, and information to billions of people. Converging fixed and wireless technologies help make the Internet a ubiquitous infrastructure, always accessible and always on, supporting a wide range of activities. An Internet of Things (IoT) refers to an overall infrastructure (hardware, software, and services) supporting the seamless integration of physical things (e.g., everyday objects) into information networks. These objects are active participants in business and information processes, exchanging data including their identities, their physical properties, and information sensed about their environment. Despite these advances in electronic technology, which allow for near instantaneous communication and data exchange between electronic devices, there can be a lack of cooperation between electronic devices to generate a feedback based on a person's emotional or mental state.

### SUMMARY

According to an embodiment of the present disclosure, an artificial intelligence-based method includes calculating, by a wearable device, a biometric index based on a plurality of biometric indicators associated with a user of the wearable device, based on the biometric index exceeding a threshold, identifying, by the wearable device, a change in a context of the user, determining, by the wearable device, whether the calculated biometric index is associated with the change in the context, based on the calculated biometric index being associated with the change, searching, by the wearable device, for an Internet of Things device available within the context, transmitting, by the wearable device, a notification to the Internet of Things device requesting assistance to the user, and in response to transmitting the notification, measuring a change in the biometric index.

Another embodiment of the present disclosure provides a computer program product based on the method described above.

Another embodiment of the present disclosure provides a computer system based on the method described above.

### BRIEF DESCRIPTION OF THE DRAWINGS

The following detailed description, given by way of example and not intended to limit the invention solely thereto, will best be appreciated in conjunction with the accompanying drawings, in which:

FIG. 1 is a block diagram illustrating a networked computer environment, according to an embodiment of the present disclosure;

FIG. 2 is a flowchart illustrating a method for generating a response based on biometric data, according to an embodiment of the present disclosure;

FIG. 3 is an exemplary implementation of the proposed system for generating a response based on biometric data, according to an embodiment of the present disclosure;

FIG. 4 is a block diagram of internal and external components of a computer system, according to an embodiment of the present disclosure;

FIG. 5 is a block diagram of an illustrative cloud computing environment, according to an embodiment of the present disclosure; and

FIG. 6 is a block diagram of functional layers of the illustrative cloud computing environment of FIG. 5, according to an embodiment of the present disclosure.

The drawings are not necessarily to scale. The drawings are merely schematic representations, not intended to portray specific parameters of the invention. The drawings are intended to depict only typical embodiments of the invention. In the drawings, like numbering represents like elements.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

As mentioned above, advances in electronic technology allow for near instantaneous communication and data exchange between electronic devices. Particularly, current wearable (smart) devices provide users with instant access to computing capabilities as they move. Wearable devices incorporate a variety of transducers, sensors and other components for detecting, sensing, and monitoring aspects of the world around them including user's physical parameters such as temperature, location, motion, heart rate, etc. These devices may also contain processing units that in conjunction with software can receive, store, analyze and transmit information from the sensed physical world. Wearable devices are non-intrusive devices users can wear on or near their bodies without impeding daily activities. In addition to personal computers, tablets, and smartphones, there is a growing number of wearable devices that can be incorporated into personal objects including, for example, clothes, eyeglasses, watches, jewelry, bracelets, ear buds, etc., which may work independently, connect to a network, or sync to other electronic devices (including surrounding IoT devices).

In some instances, certain experiences or situations can generate feelings of fear and anxiety. A person experiencing fear and anxiety may produce a biometric response that can include numerous physiological symptoms. Examples of such biometric response can include muscle tension, increased heart rate, and shortness of breath. These physical changes can be the result of a natural fight-or-flight stress response thought to be necessary for human survival. Without such stress response, it is possible a person's mind would not receive the alerting danger signal and a person's body would be unable to prepare to flee, or stay and possibly struggle when faced with imminent danger. However, these feelings of fear and anxiety can frequently come from a person's interpretation of the “potential” dangers that could immediately arise when facing a situation instead of from a real threat. For example, an individual may be experiencing for the first time a certain context or situation. The lack of knowledge and control over such new context can trigger a fear response in the individual. Additionally, numerous mental health conditions are associated with feelings of fear and anxiety, such as specific phobias, agoraphobia, social anxiety disorder, and panic disorder. For individuals having such underlying conditions, exposure to certain situations (e.g., traveling by air) can generate more than temporary worry or fear. In such situations a person can benefit from human interaction, certain coping mechanisms or soothing techniques.

Embodiments of the present invention generally relates to the field of artificial intelligence (AI), and more particularly to an Internet of Things (IoT) based cognitive system, method and computer program product for generating a response based on biometric data. The following described exemplary embodiments provide a system, method, and computer program product to, among other things, determine a user's biometric response associated with an emotional state and an active context that triggers the emotional state in the user, and provide a proactive or actual form of notification with the intent of changing the user's biometric response. Therefore, the present embodiments have the capacity to improve the technical field of artificial intelligence by creating dynamic real time interactions of IoT and user's wearable device(s) to identify a user's response to contextual changes and providing an appropriate reassuring feedback. More specifically, embodiments of the present disclosure provide an AI-based system capable of 1) capturing a user's biometric feedback or response corresponding to a current fear or anxiety state based on feed from IoT devices. If the captured biometric feedback passes a threshold, the system connects to appropriate IoT devices for positive sentiment and natural language classifier (NLC) techniques for soothing; 2) retrieving past effective ameliorative techniques to assist a user in anxiety-provoking situations; 3) crawling IoT sockets and using NLC and natural language processing (NLP) to determine help functionality to call for assistance in fear and anxiety related situations; 4) overlaying a real time dynamic biometric data generation with mobility patterns with historical data to infer when and where biometric patterns associated with fear or anxiety are generated, thus being proactive and reactive in nature; and 5) learning from biometric pattern usage to generate predictive infusion of biometric indexes.

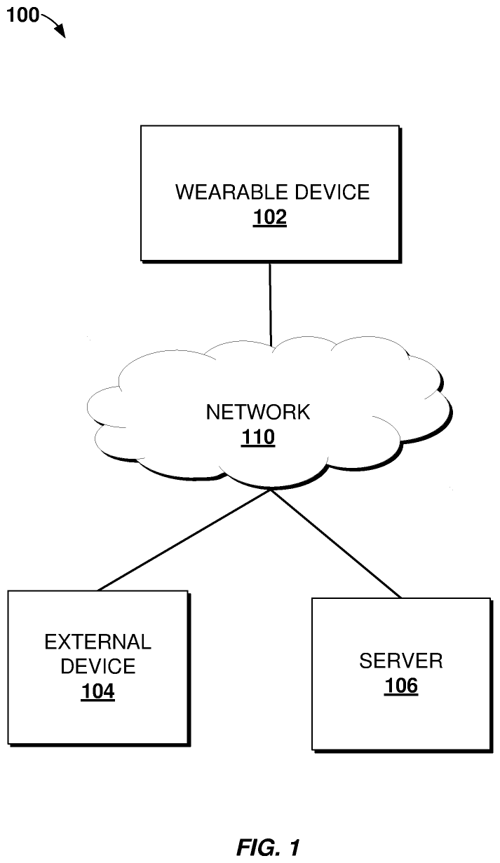

Referring now to FIG. 1, an exemplary networked computer environment 100 is depicted, according to an embodiment of the present disclosure. FIG. 1 provides only an illustration of one embodiment and does not imply any limitations regarding the environments in which different embodiments may be implemented. Many modifications to the depicted environment may be made by those skilled in the art without departing from the scope of the invention, as recited by the claims. In this embodiment, the networked computer environment 100 represents an artificial intelligence (AI) based cognitive system for generating a response based on biometric data.

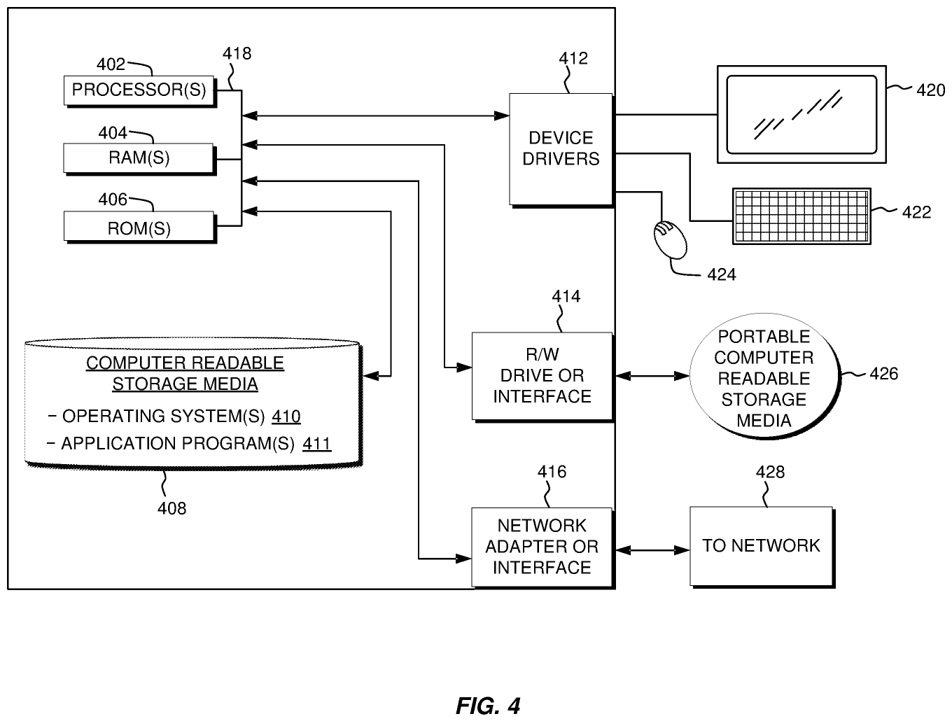

In the depicted embodiment, networked computer environment 100 includes wearable device 102, external device 104, and server 106 all interconnected over network 110. Wearable device 102, external device 104, and server 106 may include internal and external hardware components, as depicted and described in further detail with respect to FIG. 4.

Network 110 may be a local area network (LAN), a wide area network (WAN), such as the Internet, the public switched telephone network (PSTN), a mobile data network (e.g., wireless Internet provided by a third or fourth generation of mobile phone mobile communication), a private branch exchange (PBX), any combination thereof, or any combination of connections and protocols that will support communications between wearable device 102, external device 104 and server 106, in accordance with embodiments of the present disclosure. Network 110 may include wired, wireless or fiber optic connections. As known by those skilled in the art, the networked computer environment 100 may include additional computing devices, servers or other devices not shown.

In the depicted embodiment, server 106 is a server computer. In other embodiments, server 106 may be a management server, a web server or any other electronic device capable of receiving and sending data. In another embodiment, server 106 may represent a server computing system utilizing multiple computers as a server system, such as in a cloud computing environment.

The wearable device 102 includes one or more electronic devices capable of detecting various inputs from a user and transmitting associated data to external device 104 and/or server 106 via an opt-in and opt-out feature. According to an embodiment, the wearable device 102 is worn by the user. In another embodiment, the wearable device 102 is near the user. Generally, the wearable device 102 is wearable and able to detect various geographical and physiological aspects of the user. The wearable device 102 may be a personal computer, a tablet, or smartphone. Additional examples of wearable device 102 include, but are not limited to, fitness trackers, smart glasses, smart headphones/earbuds, a ring, a bracelet, a wristband or a wristwatch.

The external device 104 includes any physical object of the Internet of Things (IoT) that can be controlled by the wearable device 104 to provide assistance or feedback to the user. It should be noted that although FIG. 1 depicts only one external device 104, there can be numerous external devices 104 receiving commands from the wearable device 102. Examples of external device(s) 104 may depend on a current location of the user. For example, in embodiments in which the user is within an aircraft, external device(s) 104 may include different type of sensors, headsets, or built-in entertainment systems.

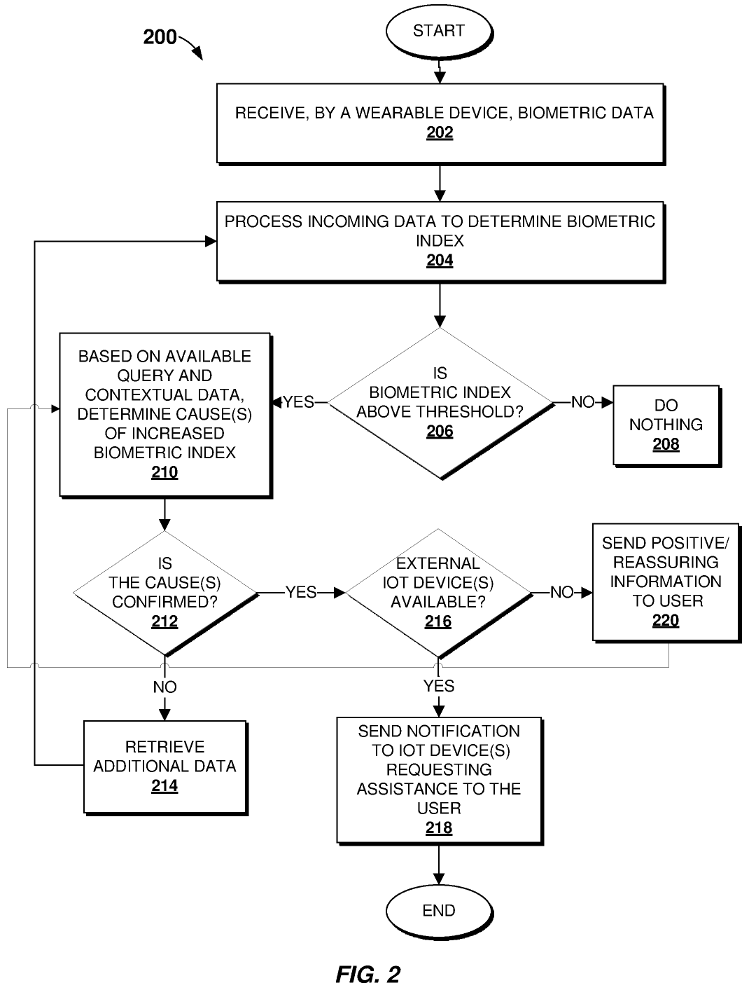

Referring now to FIG. 2, a flow chart 200 illustrating a method for reducing a level of fear of a user is shown, according to an embodiment of the present disclosure. In this embodiment, at 202, a user wearing a wearable device, such as wearable device 102 in FIG. 1, is experiencing or about to experience a determined situation. The wearable device can detect and process various inputs from the user. In some embodiments, the wearable device is continuously monitoring and receiving biometric data inputs from the user. Further, the wearable device can communicate with external IoT devices (e.g., external devices 104) available in user's current location. Specifically, the wearable device can send to and receive from available IoT devices data associated with the user and his/her surroundings.

It should be noted that any user data collection (e.g., biometric data) is done with user consent via an opt-in and opt-out feature. As known by those skilled in the art, an opt-in and opt-out feature generally relates to methods by which the user can modify a participating status (i.e., accept or reject the data collection). In some embodiments, the opt-in and opt-out feature can include a software application(s) available in the wearable device 102. Additionally, the user can choose to stop having his/her information being collected or used. In some embodiments, the user can be notified each time data is being collected. The collected data is envisioned to be secured and not shared with anyone without consent. The user can stop the data collection at any time.

At 204, the wearable device processes the received biometric data and determines a current emotional state of the user. Specifically, based on a plurality of biometric indicators (hereinafter “biometric indicators”) the wearable device identifies changes in biometric patterns of the user that may be related to a current emotional state. The biometric indicators are associated to physiological and/or behavioral characteristics corresponding to the emotional state of the user that can be determined by the wearable device. Behavioral characteristics may include, for example, the user becoming nervous, anxious, or unease. Physiological characteristics may include, for example, faster heartbeat, increased sweat level, and different facial expressions. In some embodiments, a language used by the user during the situation can be used to determine his/her current emotional state (e.g., “I'm feeling fine”, “I'm feeling nervous”, etc.). In other embodiments, user's body language can also suggest an altered emotional state (e.g., changes in a movement pattern).

It should be noted that while fear detection and amelioration is a primary embodiment of the invention, it is not the only embodiment. Embodiments of the present disclosure can provide suggestions/actions that, when followed help to ameliorate an “altered” emotional state or behavioral condition of the user including, for example, fear, anxiety, anger, or any other trait a user wishes to modify or track.

Based on the processed input (biometric) data from the user, at 206, the wearable device determines whether an emotional state of the user has changed. In the depicted embodiment, the wearable device, at 206, determines whether a biometric response of the user has varied with respect to baseline data. Specifically, a biometric index is used to quantify user's response to a determined event or situation. When the biometric index exceeds a predefined threshold value, actions are performed by the wearable device. More specifically, the biometric index quantifies the user's response and allows the wearable device, and surrounding IoT devices, determining a potential cause for such response and whether assistance is required by the user, as will be described in detail below. In some embodiments, the predefined threshold can be a user-defined parameter.

According to an embodiment, the biometric index is calculated based on the following factors associated with the user: biometric output (e.g., heartbeat, sweat level, facial expression), behavioral pattern (e.g., nervous, anxious, uneasy), language (e.g., “I'm feeling a bit better, I'm fine”), and body language (e.g., movement pattern). These factors can be captured and processed against a user's baseline using the following exemplary algorithm:

Bi=biometric output value quantified as degree

Be=behavioral value quantified as degree

L=language value quantified as degree

Bi+Be+L=Overall score=Biometric Index

If the statistical p-value of the overall score is less than 0.05 (p-value<0.05), the user's current behavior is statistically different from his/her normal behavior.

Thus, the intensity of the emotional response can be determined by the overall intensity of body measurements and calculations compared against previous baselines for the (same) user. Over time, the system may become more valuable through machine learning, offering a system with accurate detection of biometric patterns that are personalized to their normal users and their pertaining situation. Accordingly, the predictive nature of the invention and calculation of the biometric index may become more reliable as usage increases.

At 208, based on the calculated biometric index being below the predefined threshold value, the wearable device, with user's consent, continues monitoring user's physical parameters and/or behavior.

Based on the determined biometric index exceeding the predefined threshold value, the wearable device uses available query and contextual data to determine a possible cause of the increased biometric index. Specifically, the user's wearable device connects to available IoT devices to determine if there has been a change(s) in user's current context that may have triggered the change in normal biometric patterns.

Based on the wearable device not being able to determine a cause for the user's increased biometric index at 212, the wearable device retrieves, at 214, additional data associated to the current situation and returns to the processing step (204).

At 212, based on the wearable device determining the cause for the user's increased biometric index, the wearable device determines whether IoT devices suitable to provide assistance to the user are available. In response to the wearable device not being able to identify at least one suitable IoT device at 216, the wearable device, at 220, uses available or collected data regarding the identified situation that caused the biometric index to increase. According to an embodiment, the wearable device selects positive and reassuring information regarding the situation or context and send it to the user. The receiving of positive and reassuring information regarding the situation may help reducing a current biometric index of the user. Depending on the age of the user, this information may be conveyed in a variety of forms. For example, in embodiments in which the user is a child, the information is provided via the wearable device by a friendly cartoon character. In embodiments in which the user is an adult, the information is provided in the way of basic statistics. Stated differently, the proposed AI-based system monitors and predicts user's biometric patterns related to any change in a current contextual situation and sends appropriate notifications or messages to the user explaining such change(s).

In some embodiments, the wearable device can store information associated with the user's biometric response, contextual situation and soothing feedback. By doing this, the proposed AI-system can retrieve past effective ameliorative techniques to assist a user in future situations.

At 216, in response to the wearable device identifying at least one suitable IoT device, the wearable device connects to the identified IoT device and sends a notification requesting assistance to the user at 218. It should be noted that, with user's authorization, the proposed AI-based system is capable of crawling IoT sockets and using NLC and NLP to determine an available help functionality to call for assistance. Specifically, natural language processing of payload, endpoint metadata, traffic, etc., can be run to determine whether a call on a specific IoT socket will send help or assistance to the user. Manual binding or connection/broadcasting via website or IoT socket can be used to notify critical parties. By receiving the requested assistance, user's current biometric index may be reduced. Specifically, a reduced or decreased biometric index can be measured after receiving the requested assistance. In some embodiments, the user can authorize the wearable device to store this information for future use.

Further, the proposed AI-system is capable of tracking and recording a mobile location of the data as the data is being generated, thereby providing a deeper understanding of when and where changes in biometric patterns are experienced by the user(s). This data can be normalized and sanitized to be scrubbed of all personal information when recorded. This may allow for a crowdsourcing technique to be utilized for biometric baselines, averages, and known triggering locations. Based on pattern recognition, predictive techniques can be utilized to infuse the mobility-based data into the algorithm(s). As mentioned above, the collected data is envisioned to be secured and not shared with anyone without user's consent. The user can stop the data collection at any time.

In an exemplary embodiment, crowdsource biometric and geolocation information can be used to build a database of triggering locations/situations or high-risk areas. For example, a parking lot that is dark at night, a plane, an airport, a train station, an office room, etc. This data can be determined by detecting average shift in crowdsourced user's biometric pattern. User(s) can opt-in to share their social media information to an engine that may pull data such as their posts and searches which may reveal their feelings and why they are scared (e.g., Google search: Number of autonomous vehicle crashes). Similar topics between users may be derived to find the core ontological base issue (e.g., Autonomous Vehicle Crash Fear).

Further, the proposed AI-based cognitive system identifies an action performed by the user in response to the change in context, matches a history of previous actions performed by the user in response to similar situations, and provides a response based on a matching history of previous actions performed by the user that had an ameliorative effect on the biometric index. As such, based on machine learning techniques, fear-inducing events specific to the user can be predicted based on a historical data of the user.

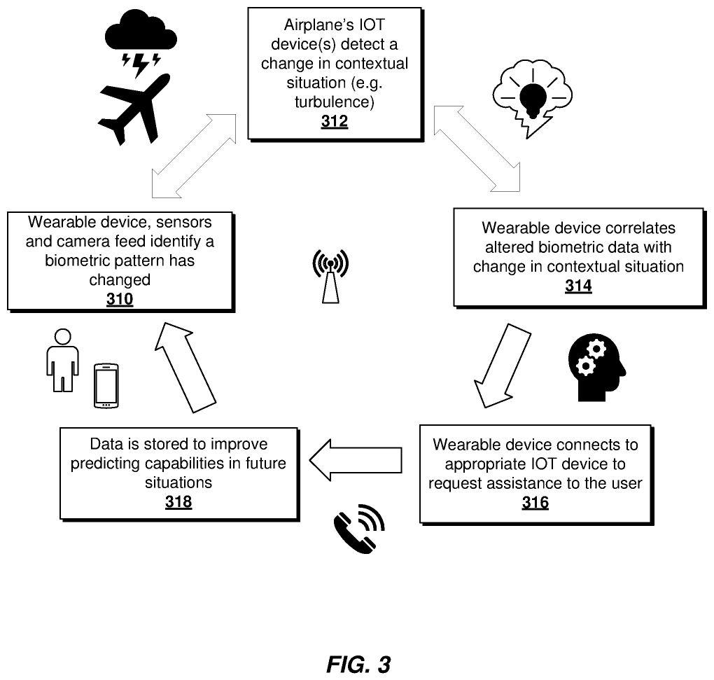

Referring now to FIG. 3, an exemplary implementation of the proposed system for generating a response to biometric data is shown, according to an embodiment of the present disclosure. In the exemplary embodiment of FIG. 3, the user is on an airplane and a change in contextual situation is initiated by a storm which causes unexpected turbulence. For illustration purposes only, without intent of limitation, the fear-inducing situation in this exemplary embodiment includes a user traveling by air. The proposed AI-based system for generating a response to biometric data can be applied to numerous situations including, but not limited to, traveling on a ship, having a surgical procedure, etc.

The wearable device receives and analyses user's biometric data including physiological parameters, tone texture, and camera feed to determine that the biometric pattern(s) has changed (310). As explained above, based on the received input, the wearable device calculates a biometric index for the user. In response to the biometric index exceeding the predefined threshold, the wearable device looks for IoT device(s) available within the airplane to identify potential changes in the user's environment that may have triggered the biometric response. In this exemplary embodiment, the wearable device receives information from airplane's weather or altitude sensors that confirm the aircraft is going through a turbulence zone. Accordingly, the wearable device correlates the user's biometric information with the airplane movement during turbulence (314). The wearable device searches for nearby IoT devices and finds, for example, a call flight attendant button that also broadcasts a signal (316). The wearable device sends a notification to this IoT device that the person in seat 32A is uncomfortable and may benefit from human reassurance.

In cases in which the wearable device cannot find IoT devices suitable for requesting assistance. The wearable device retrieves information associated with the situation. For example, how a similar problem or situation was addressed successfully in the past, how critical the situation is, how much experience the pilot has handling similar situations, technological capability to address the situation, and historical examples to address similar situation. This information is then displayed to the user for reassurance that the situation is under control and can relax.

The wearable device and different sensors installed in different devices may be storing an execution log (318) over a period of a time identifying, for example, how air turbulence was addressed by the airplane, how critical the situation was, the duration of such change in context, technologies used to handle such situation, etc. By doing this, the proposed system may augment historical data associated with the user and the current situation improving predicting capabilities and feedback for future situations.

Referring now to FIG. 4, a block diagram of components of wearable device 102, external device 104, and server 106 of networked computer environment 100 of FIG. 1 is shown, according to an embodiment of the present disclosure. It should be appreciated that FIG. 4 provides only an illustration of one implementation and does not imply any limitations regarding the environments in which different embodiments may be implemented. Many modifications to the depicted environment may be made.

Wearable device 102, external device 104, and server 106 may include one or more processors 402, one or more computer-readable RAMs 404, one or more computer-readable ROMs 406, one or more computer readable storage media 408, device drivers 412, read/write drive or interface 414, network adapter or interface 416, all interconnected over a communications fabric 418. Communications fabric 418 may be implemented with any architecture designed for passing data and/or control information between processors (such as microprocessors, communications and network processors, etc.), system memory, peripheral devices, and any other hardware components within a system.

One or more operating systems 410, and one or more application programs 411 are stored on one or more of the computer readable storage media 408 for execution by one or more of the processors 402 via one or more of the respective RAMs 404 (which typically include cache memory). In the illustrated embodiment, each of the computer readable storage media 408 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Wearable device 102, external device 104, and server 106 may also include a R/W drive or interface 414 to read from and write to one or more portable computer readable storage media 426. Application programs 411 on wearable device 102, external device 104 and server 106 may be stored on one or more of the portable computer readable storage media 426, read via the respective R/W drive or interface 414 and loaded into the respective computer readable storage media 408.

Wearable device 102, external device 104, and server 106 may also include a network adapter or interface 416, such as a TCP/IP adapter card or wireless communication adapter (such as a 4G wireless communication adapter using OFDMA technology) for connection to a network 428. Application programs 411 on wearable device 102, external device 104, and server 106 may be downloaded to the computing device from an external computer or external storage device via a network (for example, the Internet, a local area network or other wide area network or wireless network) and network adapter or interface 416. From the network adapter or interface 416, the programs may be loaded onto computer readable storage media 408. The network may comprise copper wires, optical fibers, wireless transmission, routers, firewalls, switches, gateway computers and/or edge servers.

Wearable device 102, external device 104, and server 106 may also include a display screen 420, a keyboard or keypad 422, and a computer mouse or touchpad 424. Device drivers 412 interface to display screen 420 for imaging, to keyboard or keypad 422, to computer mouse or touchpad 424, and/or to display screen 420 for pressure sensing of alphanumeric character entry and user selections. The device drivers 412, R/W drive or interface 414 and network adapter or interface 416 may include hardware and software (stored on computer readable storage media 408 and/or ROM 406).

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

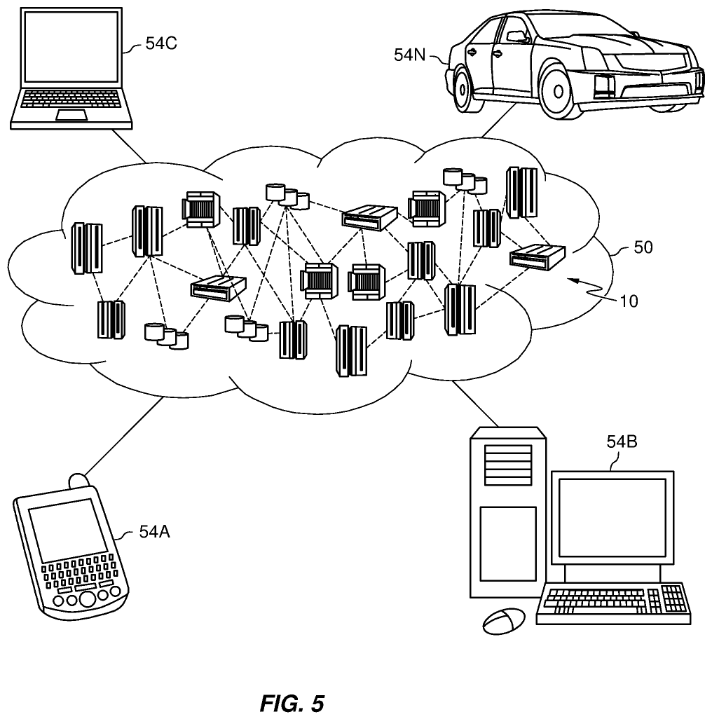

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

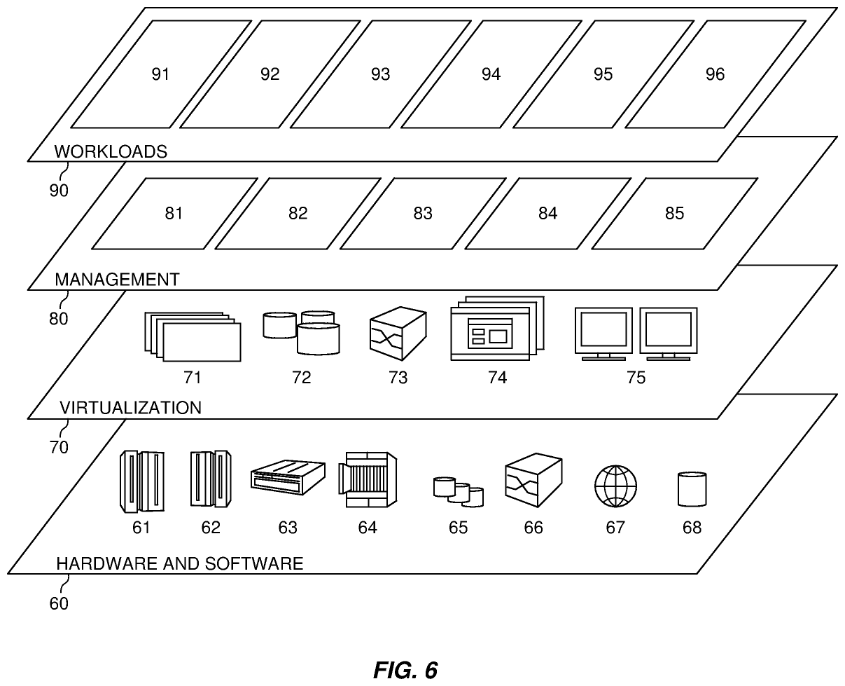

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and cognitive systems for generating a response based on biometric data 96.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While steps of the disclosed method and components of the disclosed systems and environments have been sequentially or serially identified using numbers and letters, such numbering or lettering is not an indication that such steps must be performed in the order recited, and is merely provided to facilitate clear referencing of the method's steps. Furthermore, steps of the method may be performed in parallel to perform their described functionality.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. An artificial intelligence-based method comprising:
calculating, by a wearable device, a biometric index based on a plurality of biometric indicators associated with a user of the wearable device;
based on the biometric index exceeding a threshold, identifying, by the wearable device, a change in a context of the user;
determining, by the wearable device, whether the calculated biometric index is associated with the change in the context;
based on the calculated biometric index being associated with the change, searching, by the wearable device, for an Internet of Things device available within the context;
transmitting, by the wearable device, a notification to the Internet of Things device requesting assistance to the user; and
in response to transmitting the notification, measuring a change in the biometric index.

2. The method of claim 1, wherein determining the biometric intensity index further comprises:
capturing, by the wearable device, the plurality of biometric indicators, the plurality of biometric indicators are associated to physiological and behavioral characteristics corresponding to an emotional state of the user;
determining, by the wearable device, the biometric index by calculating an overall score based on the captured plurality of biometric indicators; and
comparing, by the wearable device, the determined biometric index with a previously obtained baseline for the user.

3. The method of claim 1, wherein identifying the change in the context of the user comprises:
receiving, by the wearable device, information regarding the change in the context from surrounding Internet of Things devices.

4. The method of claim 1, wherein determining whether the biometric index is associated with the change in the context comprises:
identifying an action performed by the user in response to the change; and
matching a history of previous actions performed by the user in response to a similar situation.

5. The method of claim 1, further comprising:
matching a history of previous actions performed by the user that had an ameliorative effect on the biometric index.

6. The method of claim 1, further comprising:
based on machine learning techniques, predicting a fear-inducing event specific to the user based on a historical data of the user.

7. The method of claim 1, further comprising:
based on an Internet of Things device not being available within the context, selecting, by the wearable device, positive and reassuring information regarding the change in the context; and
delivering, by the wearable device, the positive and reassuring information to the user.

8. An artificial intelligence-based computer system comprising:
one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method comprising:
calculating, by a wearable device, a biometric index based on a plurality of biometric indicators associated with a user of the wearable device;
based on the biometric index exceeding a threshold, identifying, by the wearable device, a change in a context of the user;
determining, by the wearable device, whether the calculated biometric index is associated with the change in the context;
based on the calculated biometric index being associated with the change, searching, by the wearable device, for an Internet of Things device available within the context;
transmitting, by the wearable device, a notification to the Internet of Things device requesting assistance to the user; and
in response to transmitting the notification, measuring a change in the biometric index.

9. The computer system of claim 8, wherein determining the biometric intensity index further comprises:
capturing, by the wearable device, the plurality of biometric indicators, the plurality of biometric indicators are associated to physiological and behavioral characteristics corresponding to an emotional state of the user;
determining, by the wearable device, the biometric index by calculating an overall score based on the captured plurality of biometric indicators; and
comparing, by the wearable device, the determined biometric index with a previously obtained baseline for the user.

10. The computer system of claim 8, wherein identifying the change in the context of the user comprises:
receiving, by the wearable device, information regarding the change in the context from surrounding Internet of Things devices.

11. The computer system of claim 8, wherein determining whether the biometric index is associated with the change in the context comprises:
identifying an action performed by the user in response to the change; and
matching a history of previous actions performed by the user in response to a similar situation.

12. The computer system of claim 8, further comprising:
matching a history of previous actions performed by the user that had an ameliorative effect on the biometric index.

13. The computer system of claim 8, further comprising:
based on machine learning techniques, predicting a fear-inducing event specific to the user based on a historical data of the user.

14. The computer system of claim 8, further comprising:
based on an Internet of Things device not being available within the context, selecting, by the wearable device, positive and reassuring information regarding the change in the context; and
delivering, by the wearable device, the positive and reassuring information to the user.

15. An artificial intelligence-based computer program product comprising:
a computer readable storage medium having program instructions embodied therewith, wherein the computer readable storage medium is not a transitory signal per se, the program instructions executable by a device to cause the device to perform a method comprising:
calculating, by a wearable device, a biometric index based on a plurality of biometric indicators associated with a user of the wearable device;
based on the biometric index exceeding a threshold, identifying, by the wearable device, a change in a context of the user;
determining, by the wearable device, whether the calculated biometric index is associated with the change in the context;
based on the calculated biometric index being associated with the change, searching, by the wearable device, for an Internet of Things device available within the context;
transmitting, by the wearable device, a notification to the Internet of Things device requesting assistance to the user; and
in response to transmitting the notification, measuring a change in the biometric index.

16. The computer program product of claim 15, wherein determining the biometric intensity index further comprises:
capturing, by the wearable device, the plurality of biometric indicators, the plurality of biometric indicators are associated to physiological and behavioral characteristics corresponding to an emotional state of the user;
determining, by the wearable device, the biometric index by calculating an overall score based on the captured plurality of biometric indicators; and
comparing, by the wearable device, the determined biometric index with a previously obtained baseline for the user.

17. The computer program product of claim 15, wherein identifying the change in the context of the user comprises:
receiving, by the wearable device, information regarding the change in the context from surrounding Internet of Things devices.

18. The computer program product of claim 15, wherein determining whether the biometric index is associated with the change in the context comprises:
identifying an action performed by the user in response to the change; and
matching a history of previous actions performed by the user in response to a similar situation.

19. The computer program product of claim 15, further comprising:
matching a history of previous actions performed by the user that had an ameliorative effect on the biometric index; and
based on machine learning techniques, predicting a fear-inducing event specific to the user based on a historical data of the user.

20. The computer program product of claim 15, further comprising:
based on an Internet of Things device not being available within the context, selecting, by the wearable device, positive and reassuring information regarding the change in the context; and
delivering, by the wearable device, the positive and reassuring information to the user.
